(19) United States
(12) Patent Application Publication
(10) Pub. No.: US 2006/0026253 A1
(43) Pub. Date: Feb. 2, 2006

(54) Using windowed user interface z-order with collaboration data for improved management of acknowledge of incoming instant messages

(75) Inventors: Bethany Lyn Kessen, Austin, TX (US); Craig M. Lawton, Raleigh, NC (US); Jonathan Andrew Lewis, Morrisville, NC (US); Martin Thomas Moore, Somerville, MA (US); Jesse B. Overby III, Raleigh, NC (US); Christopher Andrew Peters, Pflugerville, TX (US); Lorin Evan Ullmann, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/902,593

(22) Filed: Jul. 29, 2004

(51) Int. Cl. G06F 15/16

(52) U.S. Cl. 709/207

(57) ABSTRACT

A method, apparatus, and computer instructions for predicting the availability of an instant messaging user in an instant messaging system and providing that information to a message sender. The present invention analyzes a user's collaborative data to determine the user's availability to respond to an instant message and monitors z-order movement of an instant messaging window on a user's screen to determine how much attention the user is paying to the instant messaging. The instant messaging application then uses the collaborative data and the z-order information to predict the availability of the user to respond to the instant message. This information is subsequently displayed to an instant messaging partner in the partner's instant messaging window.

### BACKGROUND OF THE INVENTION

1. Technical Field

The present invention relates generally to an improved data processing system and in particular, to a method, apparatus, and computer instructions for processing and displaying messages. Still more particularly, the present invention provides a method, apparatus, and computer instructions for providing information regarding responses to an instant message in an instant messaging system.

2. Description of Related Art

Instant messaging is an online chat medium, allowing users to communicate with each other and to collaborate in real-time over a network data processing system. Instant messaging is commonly used over the Internet. Instant messaging applications monitor and report the status of users that have established each other as online contacts. This information is typically presented to a user in a window. Instant messaging applications also are often used by users conducting business. By utilizing instant messaging, business users can view each other's availability and initiate a text conversation with colleagues or customers when a desired contact becomes available. Millions of users communicate using instant messaging systems every day. With instant messaging becoming an important part of both personal and business communications, functionality and usability enhancements are important to the continued success of this type of communication tool.

Current instant messaging systems provide information to a message sender regarding the response to the message. For example, information may be returned to the sender regarding if a response to the message is currently being typed. Additionally, a user may configure his messaging system to return a do not disturb flag or an “away” message to a sender if the user is busy or not in the office. However, a problem with instant messaging technology is that the information provided to the message sender offers little detail regarding how soon the sender may expect a response. In addition, if the user has configured his messaging system to return away messages, the user is not able to simultaneously send messages while away messages are being used. The user may also forget to take off the away message or the do not disturb flag. Thus, existing messaging systems only provide a message sender with the current availability status of the message recipient, and even this information may not be correct. As a result, no information predicting when the recipient will become available/unavailable and when the message sender may expect a response to his or her message is available.

Therefore, it would be advantageous to have an improved method, apparatus, and computer instructions for predicting the availability of an instant messaging user in an instant messaging system and providing this information to a message sender.

### SUMMARY OF THE INVENTION

The present invention provides a method, apparatus, and computer instructions for predicting the availability of an instant messaging user in an instant messaging system and providing that information to a message sender. The present invention analyzes a user's collaborative data to determine the user's availability to respond to an instant message. The present invention also monitors z-order movement of an instant messaging window on a user's screen to determine how much attention the user is paying to the instant messaging. The instant messaging application then uses the collaborative data and the z-order information to provide an improved method of predicting the availability of the user to respond to the instant message. This information is subsequently displayed to an instant messaging partner in the partner's instant messaging window.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram illustrating components used in managing messages in accordance with a preferred embodiment of the present invention;

FIG. 5 is a diagram illustrating an instant messaging client in accordance with a preferred embodiment of the present invention;

FIG. 6 is an example collaborative environment in which a preferred embodiment of the present invention may be implemented;

FIGS. 7A-7C are example displays illustrating how the predicted availability of a given-person is presented to a user in accordance with a preferred embodiment of the present invention;

FIG. 8 is an example preferences window for integrating calendar information to update a user's instant messaging status in accordance with a preferred embodiment of the present invention;

FIG. 9 illustrates an example of integrating availability management into various scheduling tools in accordance with the present invention;

FIGS. 10A-10F are examples of how z-order information is used to predict availability in accordance with a preferred embodiment of the present invention;

FIG. 11 is an example display for providing additional information in the partner focus area as described in FIGS. 10A-10F; and

FIG. 12 is a flowchart of a process for using z-order movement and collaboration tools to predict and display user availability in accordance with a preferred embodiment of the present invention.

### DETAILED DESCRIPTION OF THE PREFERRED EMBODIMENT

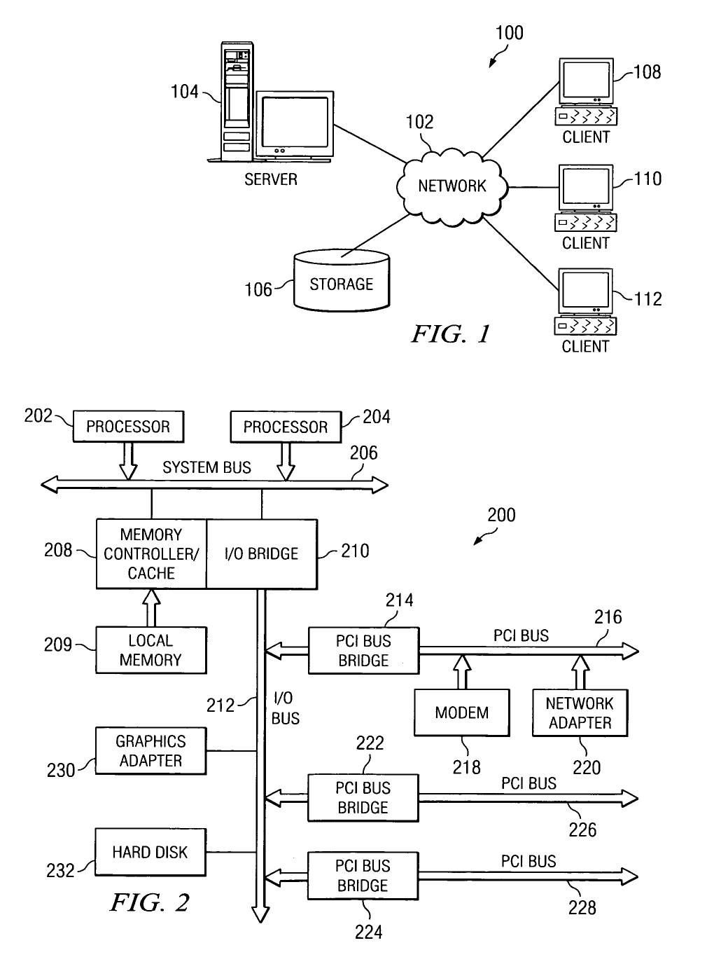

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers or personal digital assistants (PDAs). In the depicted example, server 104 provides data, such as boot files, operating system images, and applications to clients 108-112. Clients 108, 110, and 112 are clients to server 104. Server 104 may act as an instant messaging server to facilitate the exchange of messages between users at clients, such as clients 108, 110, and 112. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

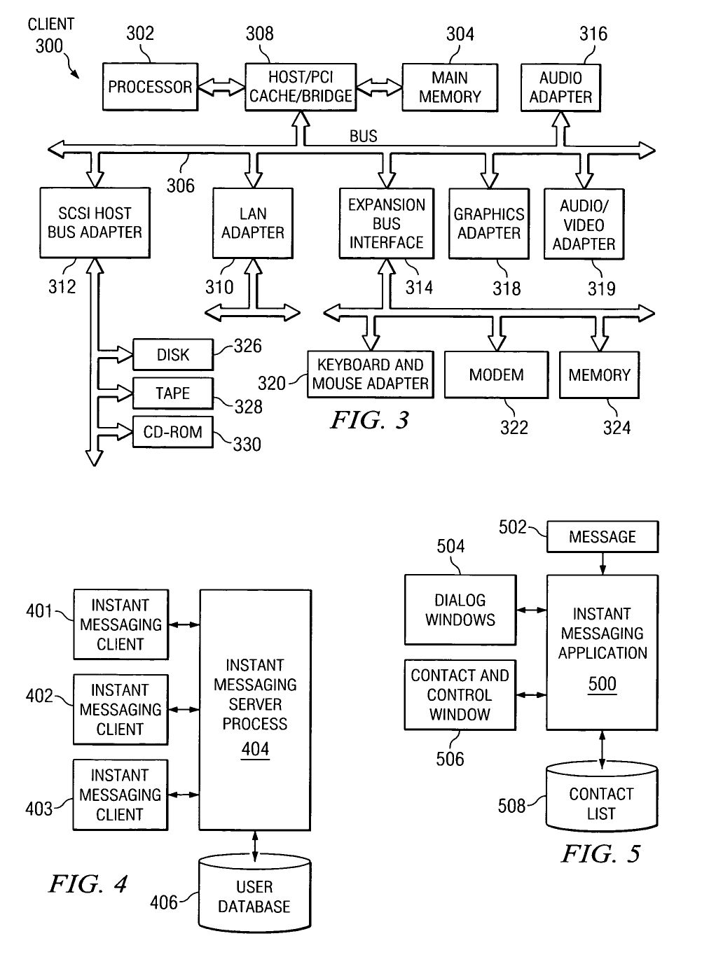

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

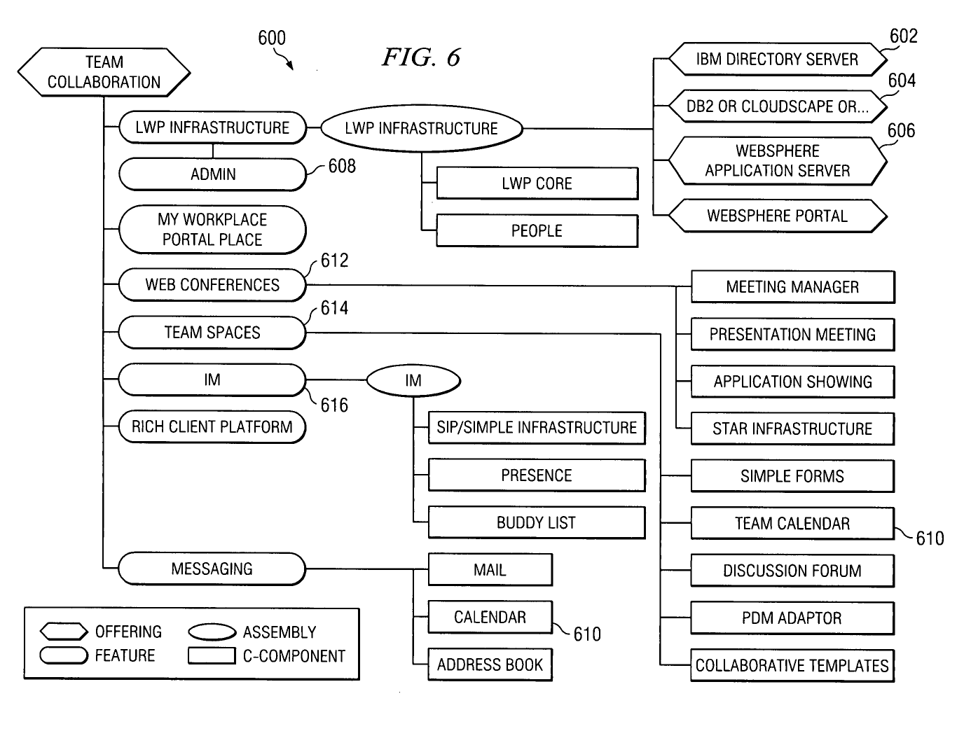

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer instructions for predicting the availability of an instant messaging user in an instant messaging system and providing that information to a message sender. The present invention offers an advantage over current instant messaging systems by allowing z-order data, such as the position and focus of the chat window, to be used in addition to collaborative tools information, such as calendar information, to create a new and improved probability of the predicted time an instant message sender may expect a response from an instant messaging partner. In this manner, a message sender is presented with information regarding when an instant messaging user will become available or unavailable.

The predicted availability of a partner may be generated based on various factors. For example, as users block off time in calendars for meetings, appointments, etc., the present invention may be used to lookup this calendar information regarding a user's availability and provide this information to the message sender. The user may also use the calendar to indicate what times for messaging the user are good, and what times are bad. In addition, the present invention may be used to check a user's calendar and report whether the user is in a meeting (and whether or not the user is on the agenda). A message sender attempting to contact the user may be given this information as well as when the meeting is scheduled to conclude. Statistics may also be generated that keep track of when a user is typically active through the course of the user's workday. This information may be used to inform others when the best time to send a message to the particular user. A user's phone activity may also be checked to determine the user's availability.

An instant messaging partner's availability status may also be tracked by determining the z-order movement of the instant messaging window on the user's screen. In other words, the position and focus of an instant messaging window on a partner's desktop may be used to provide additional information to a user. For example, if the partner's keyboard focus is on instant messaging window, the user is provided with information that conveys the partner's full attention to the instant messaging conversation. In contrast, if the user has minimized the instant messaging window, or if the instant messaging window has been covered by another messaging window or an application, the user is provided with information indicating that the partner is less focused on the instant messaging conversation.

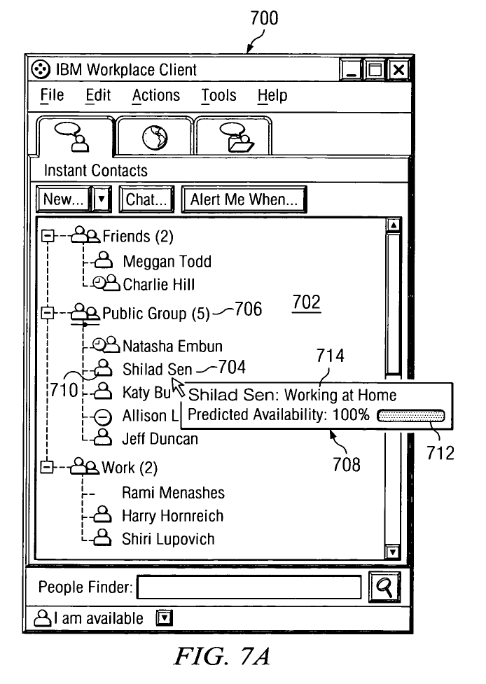

Turning now to FIG. 4, a block diagram illustrating components used in an instant messaging system in accordance with a preferred embodiment of the present invention is shown. In this illustrative example, a user at instant messaging client 401 may send or exchange messages with other users at instant messaging clients 402 and 403. These instant messaging clients may be executing on a data processing system, such as data processing system 300 in FIG. 3. The exchange of messages in these examples is facilitated through instant messaging server process 404. This process allows for users to find other users within the instant messaging system as well as aid in the exchange of messages between different users.

Depending on the particular instant messaging system, instant messaging server process 404 may only be involved in providing an indication of when particular users are online and for establishing initial contacts while users contacting users already on a buddy list may contact those users directly after seeing that a particular user is online. Instant messaging server process 404 may be located on a server, such as data processing system 200 in FIG. 2.

In these examples, the different users registered to the instant messaging system are stored in user database 406. This user database provides information needed to search for and find other users as well as contact users when they are online.

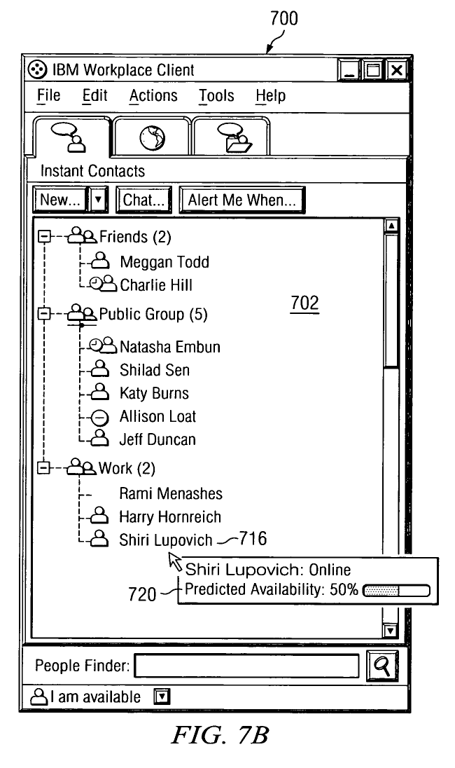

Turning next to FIG. 5, a diagram illustrating an instant messaging client is depicted in accordance with a preferred embodiment of the present invention. The components illustrated in FIG. 5 may be found in an instant messaging client, such as instant messaging client 401, 402, or 403 in FIG. 4. These components may be implemented in a data processing system, such as data processing system 300 in FIG. 3.

In the illustrative example, instant messaging application 500 processes messages, such as message 502, received from users located on remote data processing systems. As messages are received, these messages are presented in dialog windows 504. Additionally, dialog windows 504 provide an interface for a user to input text to send messages to other users.

Contact and control window 506 is presented by instant messaging application 500 to provide the user with a list of user names, as well as other information. Contact and control window 506 also provides an interface to allow a user to set different preferences. For example, the user may set passwords required to access different names used in instant messaging sessions.

Also, a user may employ contact and control window 506 to set other preferences, such as colors and fonts used in instant messaging application 500. These preferences also may include whether a picture is to be sent when a session is initiated with another user. Depending on the implementation, the preference may be set to allow a user who receives messages to retrieve images of the senders from a remote database or a local cache.

Further, a list of names presented by contact and control window 506 are stored in contact list 508 in these examples. Additional user or screen names may be added to or deleted from contact list 508. This contact list is employed in presenting the list of names within contact and control window 506.

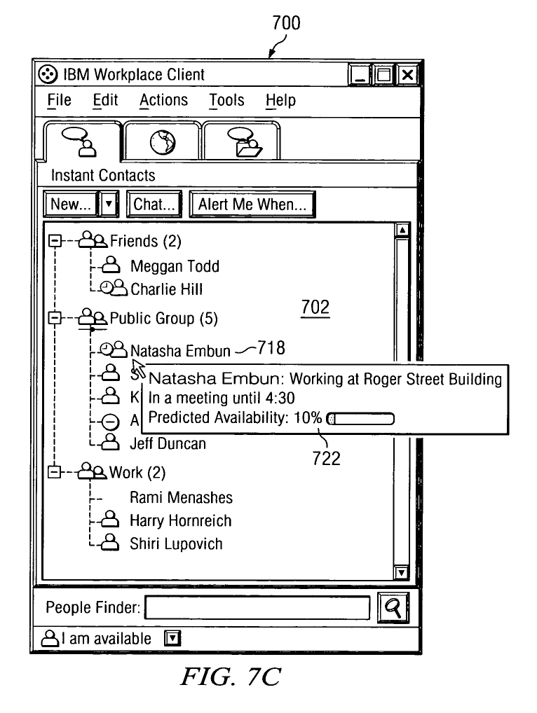

Turning now to FIG. 6, an example collaborative environment in which a preferred embodiment of the present invention may be implemented is shown. FIG. 6 displays a system architecture in which instant messaging is but a single feature that is integrated by a common infrastructure. For this exemplary embodiment, collaborative environment 600 is depicted as a Lotus Workplace (LWP) collaborative architecture, but the present invention is not intended to be so limited and may employ other types of collaborative software such as, for example, Microsoft SharePoint, etc.

LWP collaborative environment 600 includes central common services that any feature may access, such as organizational directory servers 602, common data stores (such as a DB2 Database) 604, application servers 606, and administrative services 608. Features may be added to LWP collaborative environment 600 in such a manner that existing features may easily re-use data. In addition, information from a variety of systems, such as, for example, calendaring features 610 from Web Conferences 612, Team Spaces 614, and Messaging 616, are all available to an instant messaging component by way of the LWP Infrastructure.

As LWP collaborative environment 600 comprises many discrete “components” that share a common infrastructure, these components may easily share data due to the common infrastructure. In this manner, it is possible to create the system of better predicted availability described in this patent. LWP architecture is particularly useful because customers may integrate their own components in and contribute to the system. If a customer had a custom component that they wished to add into the LWP system, they would simply add another component (similar to Messaging, Web Conferences, etc). For example, if a customer creates a “vacation planning database”, this data may be added into the predicted availability system. In addition, the customer could add the data from that custom component into the “predicted availability” data set (e.g., it may automatically append the user's status message with the vacation details).

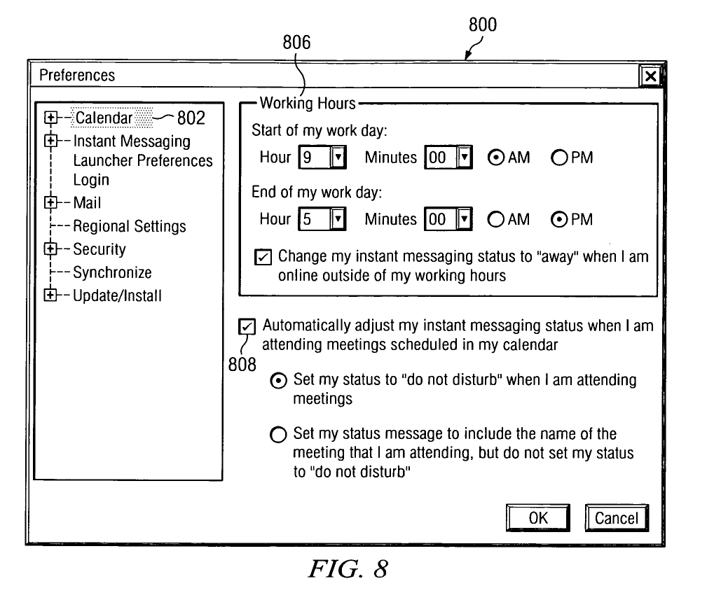

FIGS. 7A-7C are example displays illustrating how the predicted availability of a given person is presented to a user in accordance with a preferred embodiment of the present invention. In this example, IBM Workplace Client 700 is an example of a Lotus Workplace client window that may be executed on a data processing system, such as data processing system 300 in FIG. 3. For this exemplary embodiment, instant contact list 702 is depicted as an instant messaging contacts list in a Lotus Workplace Client architecture, although any instant messaging contact type display may be used to implement the present invention.

As shown in FIGS. 7A-7C, IBM Workplace Client 700 contains an instant messaging contact list, such as instant contact list 702. Instant contact list 702 includes instant messaging partners available to the user. Before a user initiates a message with an instant messaging partner, the predicted availability for the given partner may be presented to the user in a manageable and useful way. In FIG. 7A for example, if the user wants to send an instant message to a partner such as Shilad Sen 704 (shown under public group 706), the user may place the cursor over the name of the partner to determine the predicted availability of the partner. In this example, by placing the cursor over the partner name, the user is presented with cursor-over display 708. Cursor-over display 708 provides the user with predicted availability information in addition to status icon 710, such as predicted availability score 712 (e.g., “Predicted Availability: 100%”). Cursor-over display 708 may also provide other availability information to the user, for example, such as location or situation 714 of the partner (e.g., “Working at Home”).

Likewise, FIGS. 7B and 7C illustrate displaying the availability for other instant messaging partners in instant contact list 702. If the user wants to send an instant message to a partner such as Shiri Lupovich 716 as shown in FIG. 7B or Natasha Embun 718 in FIG. 7C, the user may determine the predicted availability of the partner by placing the cursor over the name of the partner. Cursor-over display 720 informs the user that Shiri Lupovich 716 is online and that there is an even possibility that the user would receive a response from Shiri Lupovich 716. Cursor-over display 722 provides further information to the user. For example, cursor-over display 722 informs the user the location where Natasha Embun 718 is working, that she is in a meeting, and that she will be in the meeting until 4:30. Cursor-over display 722 also informs the user that there is a ten percent chance that Natasha Embun 718 will respond to an instant message from the user.

As previously mentioned, the predicted availability of a partner may be generated based on various factors. For example, the present invention may be used to lookup calendar information, such as if the user is in a meeting, to determine a user's availability and present it to the message sender. Similarly, the user's calendar may also be used to determine what times for messaging the user are good, and what times are bad. Statistics may also be generated that keep track of when a user is typically active through the course of the user's workday. This information may be used to inform others when the best time to send a message to the particular user. A user's phone activity may also be checked to determine the user's availability.

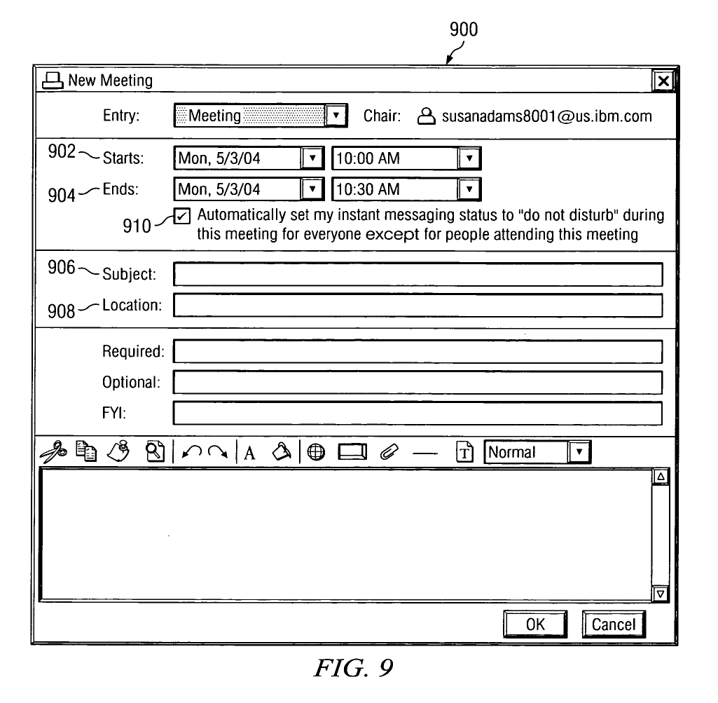

Turning now to FIG. 8, an example preferences window for integrating calendar information to update a user's instant messaging status in accordance with a preferred embodiment of the present invention. Preferences window 800 may be presented to the user in a window, such as contact and control window 506 in FIG. 5. Preferences window 800 allows users to manage their instant messaging status by selecting how they want their calendar events to affect their availability. In this manner, users are given the ability to set their availability status through a series of preferences.

Preferences window 800 is shown to contain a list of definable items, such as calendar 802. When a user selects calendar 802, the user is presented with a series of calendar preferences. Users may set preferences in the calendar to manage their availability. For example, when calendar 802 is selected, the calendar preferences presented to the user may include preferences such as “working hours” preferences 806. The user may set times for the start and end of the user's workday. Working hours preferences 806 may also provide the user with the option to set general calendaring and instant messaging availability at the same time (e.g., “Change my instant messaging status to ‘away’ when I am online outside of my working hours”).

Users may also choose how they want their calendar events to affect their availability. For example, if the user selects automatic update option 808, the user may further indicate how the user's status is displayed. For instance, the user may select whether the user's status will automatically be set to “do not disturb” when the user is in a meeting, in contrast to providing the name of the meeting the user is attending in a status message without setting the user's status to “do not disturb”. Although the example in FIG. 8 shows particular preference options, one of ordinary skill in the art would recognize that other preferences may be used in preferences window 800 to allow the user to integrate calendar information into a user's availability status.

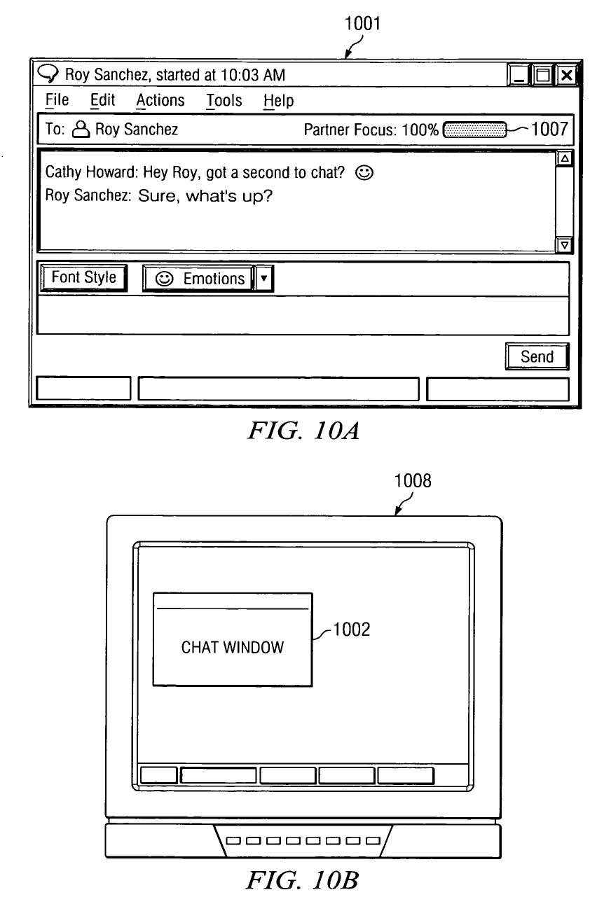

Turning now to FIG. 9, an example of integrating availability management into various scheduling tools is shown in accordance with the present invention. In this example, new meeting window 900 is shown, although any scheduling tool may be used to implement the present invention. New meeting window 900 may be presented to the user in a window, such as contact and control window 506 in FIG. 5. New meeting window 900 allows users to integrate availability management when a user creates new meetings.

New meeting window 900 is shown to comprise entries for creating a new meeting, such as start time 902 and end time 904, subject 906, and location 908. New meeting window 900 is also shown to include an availability option to the user. For example, if user selects “automatic update” option 910 when creating a new meeting, the user has chosen to be available, during the meeting period, only to those people attending that meeting. Although the example in FIG. 9 illustrates displaying integrating availability management into scheduling a new meeting, it should be noted that the availability management of the present invention may be fully integrated into any scheduling tool to implement the present invention.

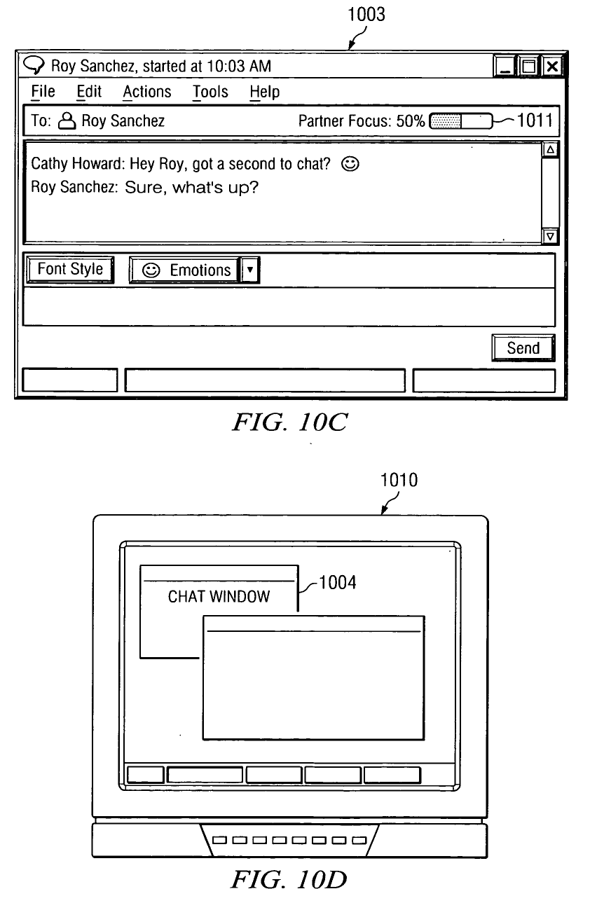

FIGS. 10A-10F are examples of how z-order information is used to predict availability in accordance with a preferred embodiment of the present invention. FIGS. 10A-10E contain example instant messaging dialog windows, such as dialog windows 1001-1006. Dialog windows 1001-1006 are examples of dialog window 504 in FIG. 5.

As previously mentioned, an instant messaging partner's availability status may be tracked by determining the z-order movement of the instant messaging window on the user's screen. This z-order data may be used alone or in combination to the collaboration tools information as described in FIGS. 7-9. In this manner, a partner's keyboard focus on an instant messaging window may be used to provide additional availability information to a user.

In the particular example in FIGS. 10A and 10B, dialog window 1001 shows a conversation being conducted between two users, Cathy Howard and Roy Sanchez. Dialog window 1001 is a dialog window shown on user Cathy Howard's desktop. Partner focus 1007 is used to provide a user, such as Cathy Howard, with availability details regarding the instant messaging partner, such as Roy Sanchez. Partner focus 1007 provides the user with a percentage score regarding how much the instant messaging partner is focused on the instant messaging conversation. For example, Roy's desktop 1008 in FIG. 10B shows that Roy's keyboard focus is in instant messaging dialog window 1002. Consequently, partner focus 1007 as shown in Cathy's dialog window 1001 is shown to be at 100%. In this manner, the amount of Roy's attention to the particular instant messaging conversation may be presented to Cathy.

In contrast, FIG. 10D illustrates the scenario where instant messaging dialog window 1004 on a partner's desktop, such as Roy's desktop 1010, has been covered by another messaging window or an application. Consequently, partner focus 1011 in Cathy's dialog window 1003 is shown to be at fifty percent. Thus, partner focus 1011 informs Cathy that Roy is less focused on the instant messaging conversation based on the position and focus of the dialog window on Roy's desktop.

Likewise, FIG. 10F illustrates the scenario where the partner has minimized instant messaging dialog window 1006 on a partner's desktop, such as Roy's desktop 1012. In response, partner focus 1013 in dialog window 1005 is shown to be at twenty percent. Thus, partner focus 1013 informs Cathy that Roy is less focused on the instant messaging conversation based on the position and focus of the dialog window on Roy's desktop.

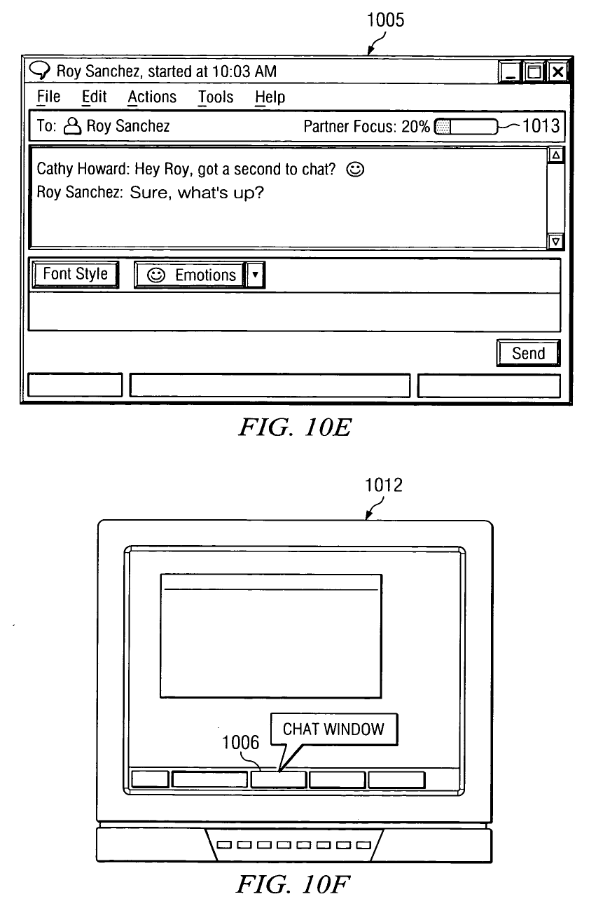

FIG. 11 is an example display for providing additional information in the partner focus area as described in FIGS. 10A-10F. In addition to the partner focus percentage score information provided to a user in FIGS. 10A-10F, partner focus area 1102 may provide additional information to a user. For example, the user may place the cursor over partner focus area 1102. In response, the user is presented with cursor-over display 1104. Cursor-over display 1104 provides the user with additional information regarding the availability of the partner in addition to the percentage score from partner focus area 1102, such as informing the user as to why the partner is unlikely to respond quickly (e.g., “He is viewing a presentation on his computer” and “He has minimized this chat window”). It must be noted that z-order information may also be used in addition to the collaboration tools information as described in FIGS. 7-9 to provide more accurate partner focus details.

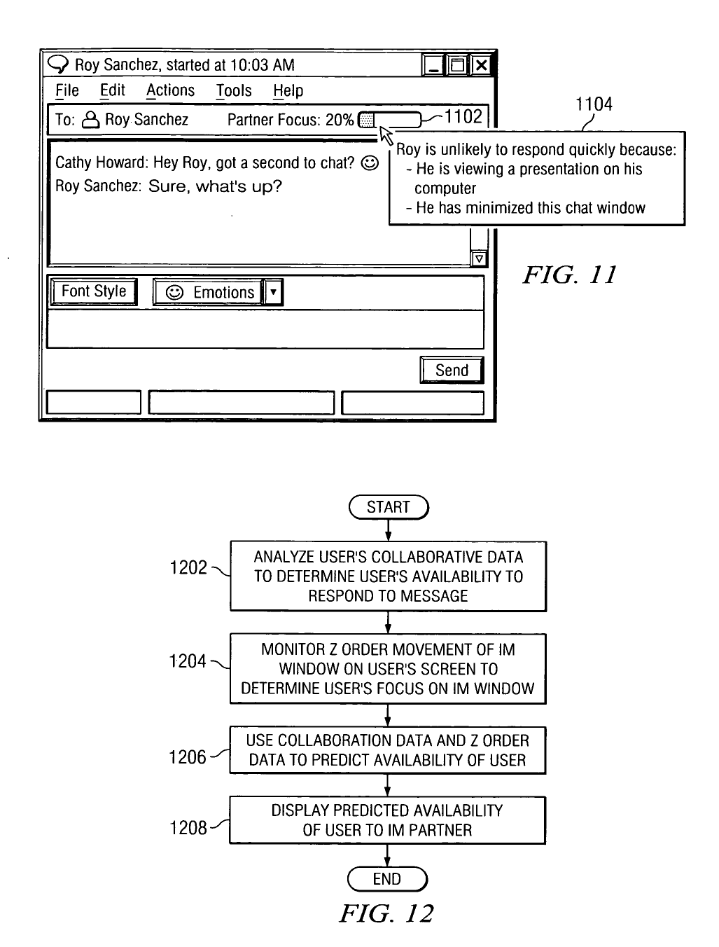

Turning now to FIG. 12, a flowchart of a process for using z-order movement and collaboration tools to predict and display user availability in accordance with a preferred embodiment of the present invention is shown. The process illustrated in FIG. 12 may be implemented in an instant messaging application, such as instant messaging application 500 in FIG. 5.

The process begins by the instant messaging application analyzing a user's collaborative data to determine the user's availability to respond to an instant message (step 1202). For example, the instant messaging application may check collaborative data stored in a user's calendar. The instant messaging application also monitors z-order movement of an instant messaging window on a user's screen to determine how much attention the user is paying to the instant messaging (step 1204). For example, if the partner's keyboard focus is on instant messaging window, the user is provided with information that conveys the partner's full attention to the instant messaging conversation. In contrast, if the user has minimized the instant messaging window, or if the instant messaging window has been covered by another messaging window or an application, the user is provided with information indicating that the partner is less focused on the instant messaging conversation. The instant messaging application then uses the collaborative data and the z-order information to predict the availability of the user to respond to the instant message (step 1206). Subsequently, this information is displayed to an instant messaging partner in the partner's instant messaging window (step 1208), with the process terminating thereafter.

Thus, the present invention provides a method, apparatus, and computer instructions for predicting the availability of an instant messaging user in an instant messaging system and providing that information to a message sender. In these depicted examples, the mechanism of the present invention utilizes z-order data, such as the position and focus of the chat window, in addition to collaborative tools information, such as calendar information, to create a new and improved probability of the predicted time an instant message sender may expect a response from an instant messaging partner. In this manner, the present invention provides an advantage over current instant messaging systems by providing a new and improved probability of the predicted time an instant message sender may expect a response from an instant messaging partner. Thus, a message sender is presented with information regarding when an instant messaging user will become available or unavailable.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in an instant messaging system for monitoring a user's predicted availability to respond to an instant message, comprising:
analyzing a user's collaborative data to determine the user's availability to respond to an instant message;
monitoring z-order movement of an instant messaging window on a user's screen to determine a user's keyboard focus on the instant messaging window;
predicting a user's availability to respond to the instant message using the collaborative data and z-order movement information; and
displaying the user's predicted availability to an instant messaging partner.

2. The method of claim 1, wherein the user's predicted availability is displayed to the instant messaging partner prior to sending the user an instant message by placing a cursor over a user's name in an instant messaging contact list.

3. The method of claim 2, wherein the instant messaging contact list contains available instant messaging partners.

4. The method of claim 1, wherein the user's predicted availability comprises a percentage score.

5. The method of claim 1, wherein the user's predicted availability comprises information regarding a user's location.

6. The method of claim 1, wherein the user's predicted availability comprises information regarding a user's activity.

7. The method of claim 6, wherein the information is based on statistics generated from a user's prior activity.

8. The method of claim 1, wherein collaborative data comprises calendar information.

9. The method of claim 8, wherein the calendar information is defined by a user.

10. The method of claim 1, wherein monitoring z-order movement of an instant messaging window includes observing the z-order position and keyboard focus of an instant messaging window on the user's screen.

11. An instant messaging system for monitoring a user's predicted availability to respond to an instant message, comprising:
analyzing means for analyzing a user's collaborative data to determine the user's availability to respond to an instant message;
monitoring means for monitoring z-order movement of an instant messaging window on a user's screen to determine a user's keyboard focus on the instant messaging window;
predicting means for predicting a user's availability to respond to the instant message by using the collaborative data and z-order movement information; and
displaying means for displaying the user's predicted availability to an instant messaging partner.

12. The instant messaging system of claim 11, wherein the user's predicted availability is displayed to the instant messaging partner prior to sending the user an instant message by placing a cursor over a user's name in an instant messaging contact list.

13. The instant messaging system of claim 12, wherein the instant messaging contact list contains available instant messaging partners.

14. The instant messaging system of claim 11, wherein the user's predicted availability comprises a percentage score.

15. The instant messaging system of claim 11, wherein the user's predicted availability comprises information regarding a user's location.

16. The instant messaging system of claim 11, wherein the user's predicted availability comprises information regarding a user's activity.

17. The instant messaging system of claim 16, wherein the information is based on statistics generated from a user's prior activity.

18. The instant messaging system of claim 11, wherein collaborative data comprises calendar information.

19. The instant messaging system of claim 18, wherein the calendar information is defined by a user.

20. The instant messaging system of claim 11, wherein monitoring z-order movement of an instant messaging window includes observing the z-order position and keyboard focus of an instant messaging window on the user's screen.

21. A computer program product in a computer readable medium for monitoring a user's predicted availability to respond to an instant message in an instant messaging system, comprising:
first instructions for analyzing a user's collaborative data to determine the user's availability to respond to an instant message;
second instructions for monitoring z-order movement of an instant messaging window on a user's screen to determine a user's keyboard focus on the instant messaging window;
third instructions for predicting a user's availability to respond to the instant message by using the collaborative data and z-order movement information; and
fourth instructions for displaying the user's predicted availability to an instant messaging partner.

22. The computer program product of claim 21, wherein the user's predicted availability is displayed to the instant messaging partner prior to sending the user an instant message by placing a cursor over a user's name in an instant messaging contact list.

23. The computer program product of claim 22, wherein the instant messaging contact list contains available instant messaging partners.

24. The computer program product of claim 21, wherein the user's predicted availability comprises a percentage score.

25. The computer program product of claim 21, wherein the user's predicted availability comprises information regarding a user's location.

26. The computer program product of claim 21, wherein the user's predicted availability comprises information regarding a user's activity.

27. The computer program product of claim 26, wherein the information is based on statistics generated from a user's prior activity.

28. The computer program product of claim 21, wherein collaborative data comprises calendar information.

29. The computer program product of claim 28, wherein the calendar information is defined by a user.

30. The computer program product of claim 21, wherein monitoring z-order movement of an instant messaging window includes observing the z-order position and keyboard focus of an instant messaging window on the user's screen.
